(19) United States
(12) Patent Application Publication
(10) Pub. No.: US 2017/0132655 A1
(43) Pub. Date: May 11, 2017

(54) System and method for making gym equipment available for easy fitness

(71) Applicant: Mary Ellen Hoye, Homer Glen, IL (US)

(72) Inventor: Mary Ellen Hoye, Homer Glen, IL (US)

(21) Appl. No.: 15/243,653

(22) Filed: Aug. 22, 2016

Related U.S. Application Data
(63) Continuation-in-part of application No. 14/196,040, filed on Mar. 4, 2014, now abandoned.

(51) Int. Cl. G06Q 30/02; G06Q 20/14; G06Q 40/08; A63B 22/02; A63B 71/06

(52) U.S. Cl. CPC G06Q 30/0241; A63B 22/02; A63B 71/0622; G06Q 40/08; G06Q 20/145; A63B 2225/20; A63B 2071/0625

(57) ABSTRACT

A system and method where fitness equipment that can be located at stores, coffee shops, airports and any other place where people gather and can easily access when they have a few extra minutes, or they must wait for a known amount of time. The fitness equipment can be accessed by membership or by credit card. An optional television monitor can display advertisements and/or fitness information or general news, weather or the like. The fitness equipment can optionally track usage by a member as part of a fitness or insurance program.

This is a continuation-in-part of application Ser. No. 14/196,040 filed Mar. 4, 2014. Application Ser. No. 14/196,040 is hereby incorporated by reference in its entirety.

### BACKGROUND

Field of the Invention

The present invention relates to fitness and gym or exercise equipment, and more particularly to a system and method for making gym equipment available in convenient places for easy fitness.

Description of the Prior Art

Many people lead lives that are so busy and scheduled such that the very need to drive to a particular gym or exercise facility steals from the thirty minutes to one hour or free time they may have for the day. It is recommended to exercise for a minimum of 20 to 30 minutes per day to keep in shape at the very least, and possibly for the purpose of keeping insurance rates lower.

It is well known that there are various stores, coffee shops and other locations located virtually everywhere, where people gather and need to visit, that are easy to access and very convenient.

It would be advantageous to have a system and method for locating gym or other exercise equipment in these stores and locations so that visitors could have the convenience of what might be called a “gym on the go” designed to accommodate people's very busy schedules and yet provide an adequate fitness opportunity.

### SUMMARY OF THE INVENTION

The present invention relates to fitness equipment that can be located at stores, coffee shops, airports and any other place where people gather or need to visit and can easily access when they have a few extra minutes, or they must wait for a known amount of time. The present invention installs fitness or exercise equipment into locations where there is no previous fitness or exercise equipment. The fitness equipment can be accessed by membership or by credit card. An optional television monitor can display advertisements and/or fitness information or general news, weather or the like. The fitness equipment can optionally track usage by a member as part of a fitness or insurance program. Reports of participation by various individuals can be directly reported to insurance companies in order to lower rates.

### DESCRIPTION OF THE DRAWINGS

Several drawings are now presented to illustrate features of the present invention.

FIG. 1 shows a floor layout of a coffee shop with an embodiment of the present invention installed.

FIG. 2 shows a diagram with embodiments of the present invention connected by a network that is tied to a billing service and to insurance.

FIG. 3 shows a block diagram of an airport system.

Several illustrations have been presented to aid in understanding the present invention. The scope of the present invention is not limited to what is shown in the figures.

### DESCRIPTION OF THE INVENTION

The present invention relates to placing several pieces of fitness equipment in stores, coffee shops or other convenient locations throughout a neighborhood for people to use when they have ten minutes or more to wait, but nothing else to do. This equipment is placed in locations that have no existing gym equipment. The equipment can be located in a separate room or cubicle or simply be off to the side. For example, a parent waiting for a child to finish a music lesson, or someone waiting for a relative dropped off at the doctor, could exercise during the wait by simply dropping into a next-door coffee shop.

The cubical or location could be equipped with a coat hanger for coats and have a friendly ambience. The invention can include an optional television that can play fitness videos, run advertisements, show weather or news or show any other programming. The store hosting the fitness equipment can charge for it by accepting a credit card, or by maintaining accounts for frequent users. Regular members could carry an access card. Different groups of participating stores can honor the same access or membership card. The store could also be paid to run particular advertisements on the television or monitor. In particular local or national advertisers can pay most of the cost of the equipment just to get healthy busy people to watch their ads. The small amount of space taken up by the equipment may also pay for itself by attracting more people into the business. Customers may arrange their schedules that they know will include waits or free periods so that they can use the equipment.

The present invention also works well in airports where people spend large amounts of time simply waiting for planes to arrive or board. A small room near the gates could attract numerous people who know they must wait another half hour to board.

An optional television monitor viewable by users of the fitness equipment can display advertisements and/or fitness information or general news, weather or the like, as well as, in airports, flight information.

The present invention is not limited just to local groups of businesses, but could be nationwide or even world-wide. The same access or membership card could, for example, be recognized at every airport, or at every coffee shop of a certain brand, or even more generally, be universally recognized. Billing and reimbursement to the store could be handled online by one of several universal billing services known in the art. Any payment system, and in particular, any online payment system is within the scope of the present invention.

Typical fitness equipment can include a stepper, a treadmill, bicycle or spin-bike, possibly weights and any other type of fitness or exercise equipment. Any type of fitness equipment is within the scope of the present invention. For regular members, the equipment in a group of stores could maintain a fitness record or even tracking for insurance credit. The system can even be part of a health care insurance program.

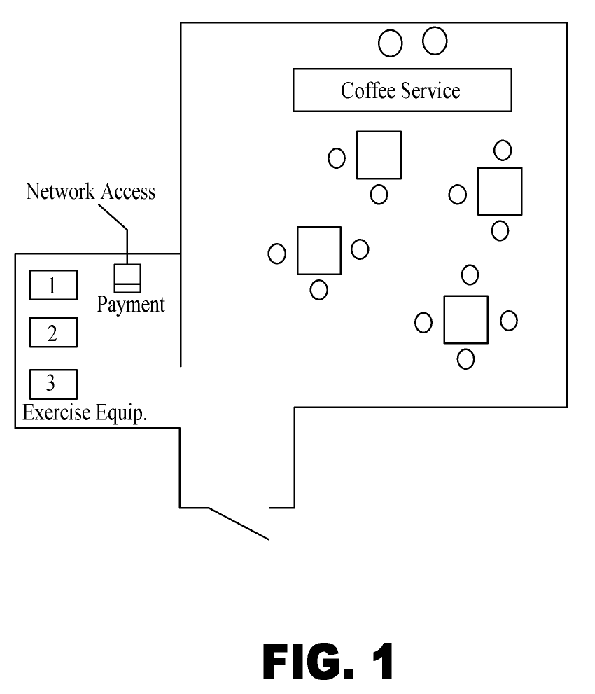

FIG. 1 shows a coffee shop with fitness equipment located in a room adjacent the entrance. Several pieces of equipment can be seen, along with a payment station that can accept either a credit card or a membership card, and which has network access.

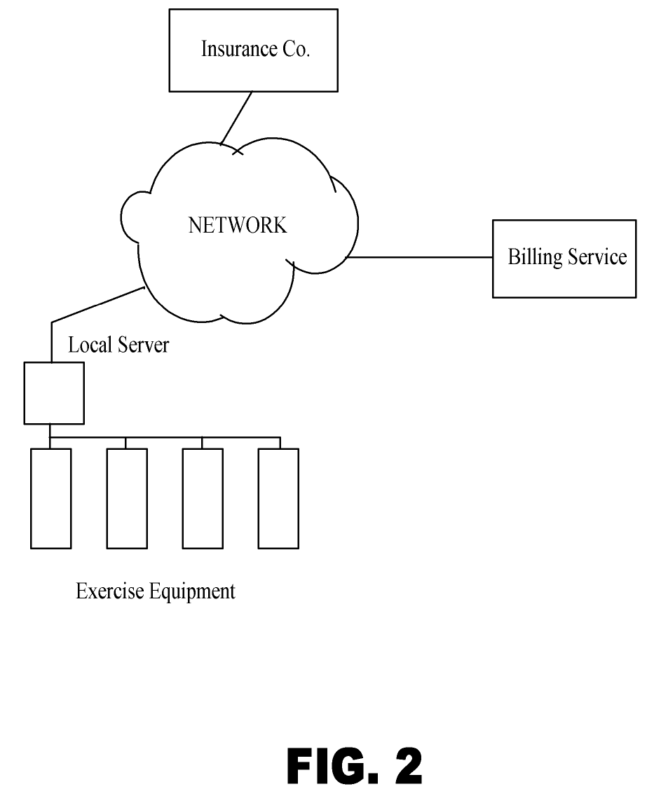

FIG. 2 shows a server managing several pieces of exercise equipment in a retail establishment coupled to a network that ultimately connects to a billing service and an optional insurance company. The fitness equipment can report usage directly to a billing service, or it can maintain local billing or be rented for particular periods of time. There can be a local pay station where a credit card or membership card can be presented. The local pay station typically accepts cash as well as credit cards and can optionally be in communication with a remote server or remote billing service that maintains membership accounts. The local pay station can directly control the fitness equipment or simply be tied to the network, with the fitness equipment being controlled and monitored by the remote server.

The present invention requires fitness equipment to be installed in locations where no fitness equipment presently exists such as coffee shops and airport waiting areas. The present invention is not directed at expanding a gym or other place where fitness equipment exists into a second type of business such as a medical business.

Because people can lose track of time while exercising, embodiments of the present invention can provide audio or visual reminders that a particular period of time has passed. For example, if an airport passenger has forty five minutes to return to the gate for boarding, an alarm time can be entered at the pay station or into a console on the fitness equipment itself such as a console on a treadmill. When the desired time has elapsed, if the user is still using the equipment, an audio signal can be initiated at the equipment to remind the user that they must stop exercising and proceed to whatever task they must next do. An example is a treadmill. If the user is still using the treadmill when the predetermined time has elapsed, an audio beep or other alarm can sound at that treadmill. Alternatively, the treadmill can be made to slow down and stop when the predetermined time has passed.

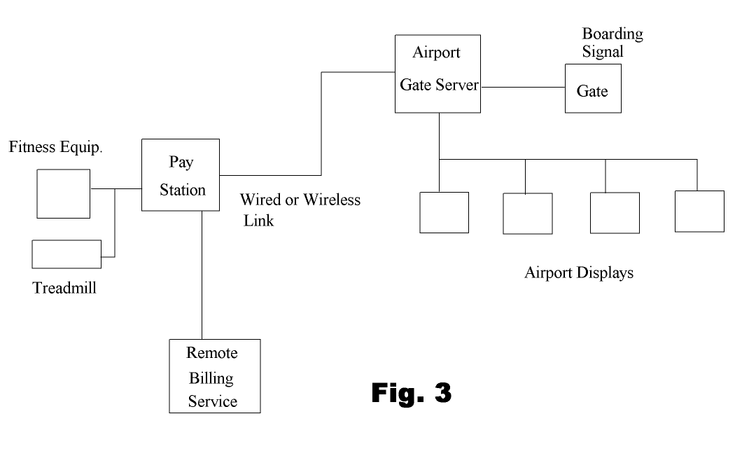

In the case of an airport, the display screen can be made to flash and announce the beginning of boarding for particular flights. This requires either the pay station or the exercise equipment to be also coupled to an airport gate system so that when a particular gate announces that boarding has commenced, the display screen or monitor can be made to flash with boarding announcements. This is shown in FIG. 3. The coupling can be wireless or wired into an existing airport system. Typically, when a gate is ready to start boarding, the gate attendant at the gate dials a particular number or otherwise activates a local boarding announcement that displays throughout the airport on airport local and remote displays. This is a boarding signal. The pay station can tie into this system. In some embodiments, users can specify that their time should end when a particular flight announces boarding. In this case, the pay station or exercise equipment can recognize that a certain flight boarding announcement is being made that is the flight the passenger specified, and directly cause the treadmill or other exercise equipment to slow down and safely stop while optionally announcing locally the fact that that flight is boarding.

FIG. 3 shows a pay station tied to several pieces of exercise equipment including a treadmill in a passenger waiting area near airport gates. The pay station is tied into an airport gate server either wirelessly or wired with Ethernet, WiFi, Bluetooth, Zigbee or any other wireless or wired communication method. When a boarding signal is activated by an attendant at a gate, the airport server sends a message to the pay station or directly to the exercise equipment or directly to the monitor near the exercise equipment. The fact that boarding has commenced for a certain flight can cause an announcement to appear on the monitor screen, or it can cause an alarm at the passenger's exercise equipment. In some embodiments, the boarding signal can cause the passengers exercise equipment to slow and stop.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A method for allowing customers to exercise while waiting for service comprising:
placing a plurality of fitness or exercise equipment in a non-gym retail business establishment having no existing gym equipment, said fitness or exercise equipment being adapted to be easily accessible to users during wait times, said fitness or exercise equipment including at least a treadmill;
coupling at least said treadmill to a remote server over a network, wherein the treadmill reports usage of the treadmill to the remote server,
placing a monitor near said fitness or exercise equipment adapted to display advertisements;
placing a pay station in said business establishment, said pay station also in communication with the billing service, the pay station accepting cash, credit cards or membership cards to pay for using said treadmill.

2. The method of claim 1 further comprising issuing membership cards to users allowing access to said fitness or exercise equipment.

3. The method of claim 1 wherein said users are billed on their credit cards for using said fitness or exercise equipment.

4. The method of claim 1 further comprising coupling said fitness or exercise equipment to an insurance company over said network, wherein the insurance company receives reports when members use said fitness or exercise equipment.

5. The method of claim 1 further comprising receiving a predetermined future time or time duration at the pay station or at the treadmill, and causing an alarm or indication to initiate at the treadmill when the future time arrives or the time duration passes.

6. A method for allowing airline passengers to exercise while waiting for flights comprising:
placing a plurality of fitness or exercise equipment in an airport waiting area having no existing gym equipment, said fitness or exercise equipment being adapted to be easily accessible to users during wait times for flights, said fitness or exercise equipment including at least a treadmill;
coupling at least said treadmill to a remote server over a network to a remote server adapted to track equipment usage,
placing a pay station in said airport waiting area, the pay station accepting cash, credit cards or membership cards to pay for using said treadmill,
placing a monitor near said fitness or exercise equipment adapted to display flight information;
receiving from the passenger a predetermined future time or time duration at the pay station, and causing an alarm or indication to initiate at the treadmill when the future time arrives or the time duration passes.

7. The method of claim 6 further comprising sending a message to an insurance company over the network reporting that a particular user has used said fitness or exercise equipment and for how long.

8. The method of claim 6 wherein the monitor is coupled to an airport gate communication system so that boarding announcements may be displayed on said monitor.

9. The method of claim 8 further comprising receiving a flight number from a passenger using the treadmill before usage starts, and causing the treadmill to slow down and then stop when boarding for that flight is announced.

10. A system for improving fitness comprising:
a plurality of fitness or exercise equipment placed in a coffee shop having no previously existing gym equipment, said fitness or exercise equipment being located to be easily accessible to customers;
a network connection coupling said fitness or exercise equipment to a billing service over a network, the billing service constructed such that the fitness or exercise equipment reports usage to the billing service and the billing service charges the users for using the fitness or exercise equipment either directly through an attached pay station in the coffee shop that accepts cash or credit cards, or indirectly through membership cards readably by the pay station;
a monitor located near said fitness or exercise equipment adapted to display advertisements and/or announcements.

11. The system of claim 10 wherein the billing service is configured to send a message to an insurance company over the network reporting that a particular user has used said fitness or exercise equipment and for how long.
